(19) United States
(12) Patent Application Publication
(10) Pub. No.: US 2024/0408616 A1
(43) Pub. Date: Dec. 12, 2024

(54) ELECTRIFICATION UNIT AND ELECTROSTATIC PRECIPITATOR COMPRISING SAME

(71) Applicant: Hanon Systems, Daejeon (KR)

(72) Inventors: Ji-Yong Park, Daejeon (KR); Jae Ho Kim, Daejeon (KR); Su Jin Woo, Daejeon (KR)

(21) Appl. No.: 18/697,497

(22) PCT Filed: Nov. 4, 2022
(86) PCT No.: PCT/KR2022/017218

§ 371 Date: Apr. 1, 2024

(30) Foreign Application Priority Data
Dec. 29, 2021 (KR) 10-2021-0190789

(51) Int. Cl. B03C 3/38; B01D 53/86; B03C 3/09; B03C 3/41

(52) U.S. Cl. CPC B03C 3/38; B01D 53/8675; B01D 53/8687; B03C 3/09; B03C 3/41; B01D 2255/1021; B01D 2255/20707; B01D 2255/2073; B01D 2257/106; B01D 2257/708; B01D 2258/06

(57) ABSTRACT

The present invention relates to an electrification unit and an electrostatic precipitator comprising same. The electrification unit includes: an electrification frame having a through-hole formed to pass through both surfaces thereof in a direction in which air including dust particles flows; a counter electrode coupled to the electrification frame; and a discharge electrode coupled to the electrification frame and causing corona discharge with respect to the counter electrode, wherein a catalyst layer capable of decomposing or removing ozone is coated on a surface of the counter electrode to decompose, reduce and remove ozone generated by corona discharge, and decompose and remove harmful gas.

### CROSS REFERENCE TO RELATED APPLICATIONS

This patent application is a national phase under 35 U.S.C. § 371 of International Patent Application No. PCT/KR2022/017218 filed Nov. 4, 2022, which claims the benefit of priority from Korean Patent Application No. 10-2021-0190789 filed Dec. 29, 2021, each of which is hereby incorporated herein by reference in its entirety for all purposes

### TECHNICAL FIELD

The present invention relates to an electrification unit and an electrostatic precipitator that can electrically charge and adsorb the dust particles contained in the air in air conditioning devices such as air conditioners or air purifiers.

### BACKGROUND ART

In general, electrostatic precipitators are widely used in air conditioning systems and humidifiers for buildings and vehicles. After charging dust particles to a specific charge through the corona discharge phenomenon, a dust collection unit collects the dust particles using electrical attraction.

FIGS. 1 and 2 are a plan view and partial cross-sectional view of a conventional electrostatic precipitator and electrification unit.

As shown, the conventional electrostatic precipitator largely includes an electrification unit 10 and a dust collection unit 20. The dust particles charged with a specific charge while passing through the electrification unit 10 may be adsorbed and collected as they pass through the dust collection unit 20.

The electrification unit 10 may include an electrification frame 11 in the shape of a frame formed by penetrating in the direction in which dust flows, and an electrification plate 12 that is coupled to the electrification frame 11 and is formed approximately perpendicular to the direction in which dust flows. Here, a plurality of electrification holes 13 is formed in the electrification plate 12 in the direction through which dust particles flow, and the electrification unit 10 may further include a discharge pin 14 that applies high voltage to dust particles at a position corresponding to the electrification hole 13. In addition, the plurality of electrification pins 14 may be electrically connected by being coupled to an electrode rod 15.

Therefore, when a high voltage is applied to the electrification plate 12 and discharge pin 14, the dust particles are charged with a specific charge by a corona discharge phenomenon that occurs between the inner peripheral surface of the electrification hole 13 and the discharge pin 14. Further, in the dust collection unit 20, the dust particles that are charged while passing through the electrification unit 10 and have a specific charge are collected and removed by electrical attraction using opposite charge characteristics.

Here, in the case of the conventional electrostatic precipitator, there is a problem in that ozone harmful to the human body is generated by corona discharge in the electrification unit 10 that charges dust particles. Further, it has the disadvantage of not being able to remove harmful gases such as volatile organic compounds (VOC) introduced from the outside.

### DOCUMENTS OF RELATED ART

### Patent Document

KR 10-2021-0054719 A (2021 May 14.)

### DISCLOSURE

### Technical Problem

The present invention has been devised to solve the problems described above, and the object of the present invention is to provide an electrification unit capable of decomposing and removing the ozone caused by corona discharge, and decomposing and removing harmful gases, and an electrostatic precipitator including the electrification unit.

### Technical Solution

An optical communication device according to

In order to achieve the above object, an electrification unit of the present invention may comprise an electrification frame having a through-hole formed to pass through both surfaces thereof in a direction in which air including dust particles flows; a counter electrode coupled to the electrification frame; and a discharge electrode coupled to the electrification frame and causing corona discharge with respect to the counter electrode, wherein a catalyst layer capable of decomposing or removing ozone is coated on a surface of the counter electrode.

In addition, the discharge electrode may include an electrode rod and a discharge pin protruding from the electrode rod, the counter electrode may be formed in a form of a plate whose thickness is relatively thin compared to a length in width and longitudinal directions, and the counter electrode may be disposed so that a surface in the width direction faces the discharge electrode, and the surface in the width direction of the counter electrode may be spaced apart from the discharge pin and may be formed to surround a periphery of the discharge pin.

In addition, the counter electrode may include one layer in the direction in which the air flows, or the counter electrode may include two or more layers and the layers may be spaced apart from each other in a thickness direction and stacked.

In addition, the discharge electrode may be formed in a form of a wire, the counter electrode may be formed in a form of a plate whose thickness is relatively thin compared to horizontal and vertical lengths, and a surface in a thickness direction of the counter electrode may be disposed to face the discharge electrode in the form of wire.

In addition, the counter electrode may be connected to a low voltage side, and the discharge electrode may be connected to a high voltage side.

In addition, the catalyst layer may be made of a material containing TiO2.

In addition, the catalyst layer may be made of a material containing an active material based on TiO2 that promotes a catalytic reaction.

In addition, the active material may include one or more of Pt and Mn.

In addition, the catalyst layer may be made of a material containing MnO2.

In addition, the catalyst layer may be made of a catalyst material capable of decomposing harmful gases including a volatile organic compound.

Further, an electrostatic precipitator of the present invention may comprise the above electrification unit; and a dust collection unit which is stacked on one side of the electrification unit in the direction in which the air flows and collects the dust particles included in the air passing through the electrification unit by electrical attraction.

### Advantageous Effects

The electrification unit and electrostatic precipitator including the same of the present invention have the advantage of being able to reduce ozone generation by decomposing and removing the ozone generated during corona discharge in the electrification unit.

In addition, it has the advantage of being able to remove harmful gases such as volatile organic compounds (VOC) introduced from the outside.

In addition, since a catalyst material capable of decomposing and removing ozone can be coated on the counter electrode with a relatively large surface area, it is easy to manufacture and has the advantage of preventing the coated catalyst material from falling off.

### BRIEF DESCRIPTION OF THE DRAWINGS

FIG. 1 shows a plan view of a conventional electrostatic precipitator and electrification unit.

FIG. 2 shows partial cross-sectional view of a conventional electrostatic precipitator and electrification unit.

FIG. 3 shows an assembled perspective view of an electrification unit according to the first embodiment of the present invention.

FIG. 4 shows partially enlarged view of an electrification unit according to the first embodiment of the present invention.

FIGS. 5 and 6 show perspective views of an embodiment in which a catalyst layer is formed on a counter electrode in an electrification unit according to the first embodiment of the present invention.

FIG. 7 shows an assembled perspective view of an electrification unit according to the second embodiment of the present invention.

FIG. 8 shows a partially enlarged view of an electrification unit according to the second embodiment of the present invention.

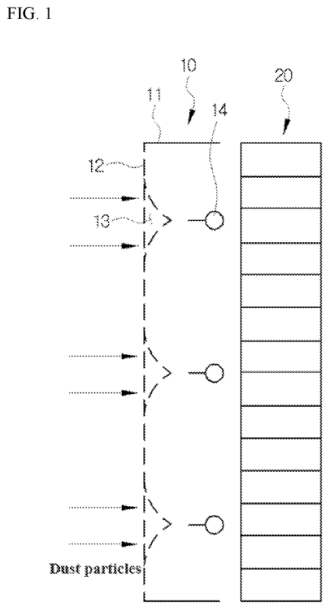

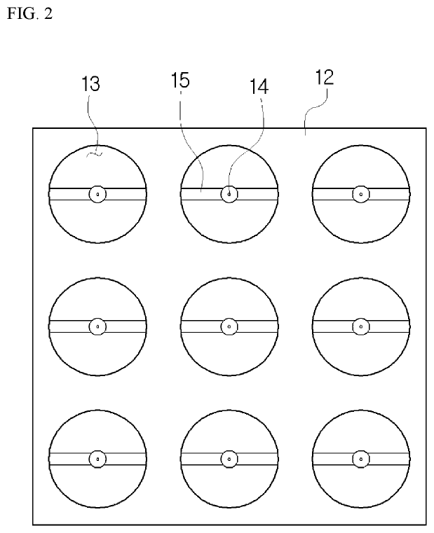

### MODE FOR INVENTION

Hereinafter, an electrification comprising the above-described configuration and electrostatic precipitator including the same of the present invention will be described in detail with reference to the accompanying drawings.

### Embodiment 1

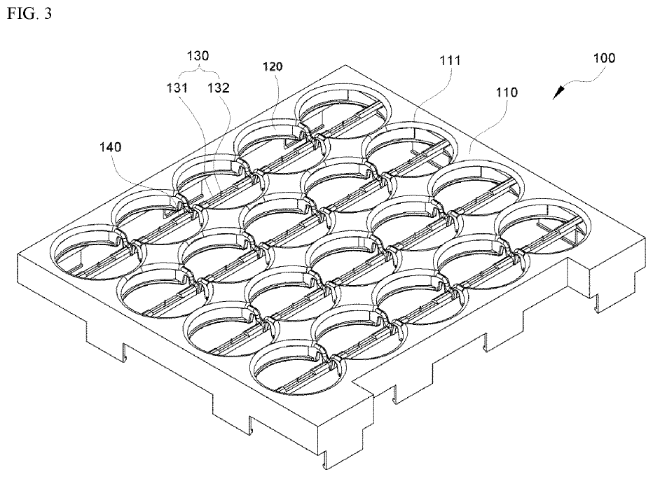

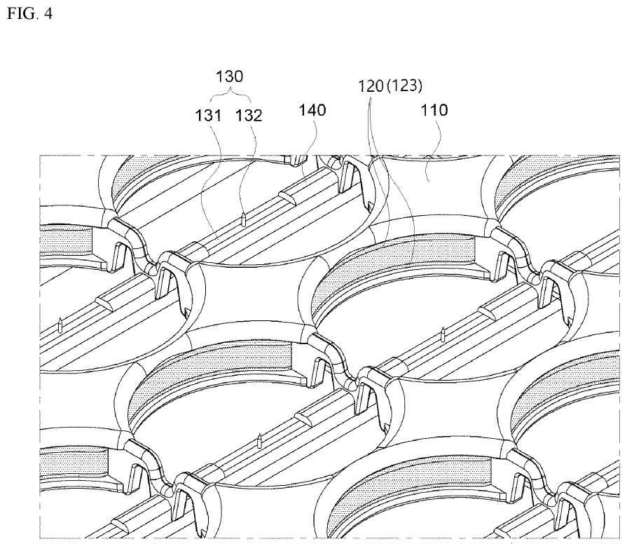

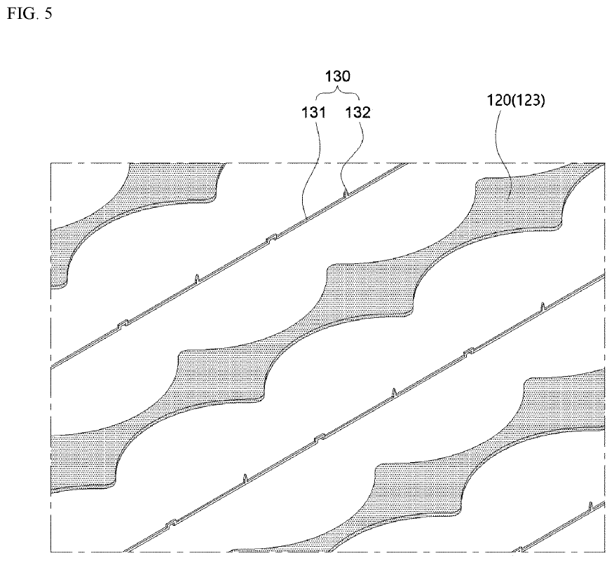

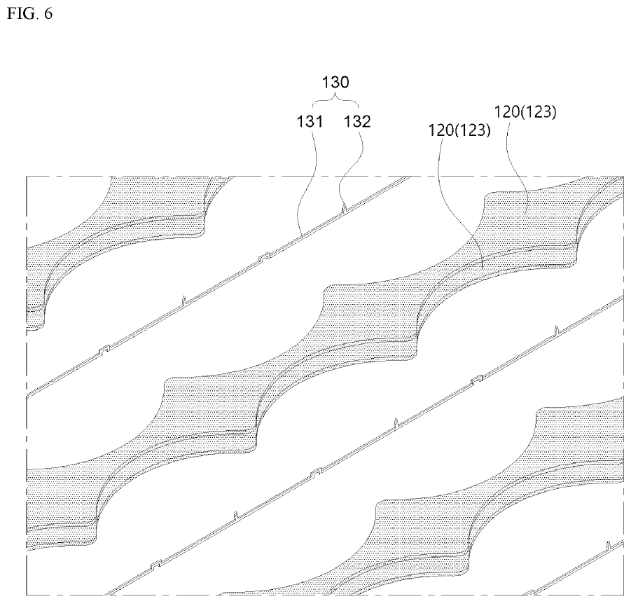

FIGS. 3 and 4 are an assembled perspective view and partially enlarged view of an electrification unit according to a first embodiment of the present invention. FIGS. 5 and 6 are perspective views of an embodiment in which a catalyst layer is formed on a counter electrode in an electrification unit according to a first embodiment of the present invention.

As shown, an electrification unit 100 according to the first embodiment of the present invention may be configured to largely include a electrification frame 110, an counter electrode 120, and a discharge electrode 130, and may be configured to further include a rod cover 140.

The electrification frame 110 is a part that forms the outer shape of the electrification unit 100 and, for example, may be formed in the form of a square panel on a plane perpendicular to the direction in which air flows. In addition, the electrification frame 110 may be spaced apart along the circumference to form a coupling part for coupling to the dust collection unit. The electrification frame 110 may be formed with a plurality of through holes 111 penetrating both sides in the vertical direction, which is a direction in which air flows, and the plurality of through holes 111 may be arranged in rows and columns. In addition, the electrification frame 110 may be made of an electrically insulating material such as plastic, and may be formed through injection molding or the like. Although not shown, a fastening part to which the counter electrode 120 may be coupled and fixed may be formed in the electrification frame 110.

The counter electrode 120 may be formed in a shape corresponding to the shape of the portion of the electrification frame 110 in which the through hole 111 is not formed in the direction in which air flows, and the counter electrode 120 may be formed as a plurality of separate electrodes and each may be coupled to and fixed to the electrification frame 110. In addition, the counter electrode 120 may be electrically connected to the low voltage side of a high voltage direct current power supply. The counter electrode 120 may be formed with a fixing part such as a hole that can be coupled to and fixed to the fastening part of the electrification frame 110. In addition, the counter electrode 120 may be formed in the form of a plate whose thickness is relatively thin compared to a length in the width and longitudinal directions, and the counter electrode 120 may be disposed so that a surface in the width direction faces the discharge electrode 130, and a surface in the thickness direction is perpendicular to the direction in which air flows. Here, the surface in the width direction of the counter electrode 120 may be spaced apart from the discharge pin 132 of the discharge electrode 130 and may be formed to surround the periphery of the discharge pin 132. In addition, the counter electrode 120 may include one layer (one plate). Alternatively, the counter electrode 120 may include two layers (two plates), and the two plates may be stacked and arranged to be spaced apart in the thickness direction. Here, a spacer may be interposed between the two plates constituting the counter electrode 120 to couple them. In addition, the counter electrode 120 may be formed of a metal material, which is an electrically conductive material, and a catalyst layer 123 capable of decomposing or removing ozone may be coated on the surface of the counter electrode 120.

The discharge electrode 130 may be disposed along the through holes 111 of the electrification frame 110 when viewed in the direction of air flow, and the discharge electrode 130 may be coupled to and fixed to the electrification frame 110. For example, the discharge electrode 130 may include an electrode rod 131 extending approximately along the longitudinal direction and a discharge pin 132 extending toward the upstream side in the direction in which air flows in the electrode rod 130. Here, the discharge pins 132 may be disposed at the center of the arc formed by the width direction side of the counter electrode 120 when viewed in the direction in which air flows. In addition, the discharge electrode 130 may be electrically connected to the high voltage side of a high voltage direct current power supply. Therefore, when high voltage power is applied to the discharge electrode 130 and counter electrode 120, corona discharge may occur between the discharge electrode 130 and the counter electrode 120.

The discharge electrode 130 may be coupled to the rod cover 140, and the rod cover 140 may be coupled to and fixed to the electrification frame 110. A groove and hole of a shape corresponding to the discharge electrode 130 are formed in the rod cover 140, and the electrode rod 131 is inserted into the groove of the rod cover 140 and the discharge electrode 130 may be exposed to the outside through the hole. The rod cover 140 may be made of an electrically insulating material such as plastic.

The catalyst layer 123 may be coated on the entire surface of the counter electrode 120. Here, the catalyst layer 123 may be made of a material that can decompose or remove ozone that may be generated during corona discharge. For example, the catalyst layer 123 is made of a material containing TiO2 and can reduce ozone generation by decomposing the ozone generated during corona discharge. In addition, TiO2, which constitutes the catalyst layer 123, may decompose and remove harmful gases such as volatile organic compounds (VOC), so that ozone and harmful gases introduced from the outside may be removed at the same time. In addition, the catalyst layer 123 may be made of a material containing an active material that promotes a catalytic reaction based on TiO2, and the active material may include one or more of Pt and Mn. Thus, the catalytic reaction of the catalyst layer 123 can be promoted and the removal effect of ozone and harmful gas can be improved.

In addition, the catalyst layer 123 may be made of a material containing MnO2, an ozone catalyst capable of removing ozone. Here, the catalyst layer 123 may further include a catalyst material capable of decomposing harmful gases including volatile organic compounds.

Therefore, the electrification unit and electrostatic precipitator including the same of the present invention have the advantage of being able to reduce ozone generation by decomposing and removing the ozone generated during corona discharge in the electrification unit. In addition, a catalyst material that can decompose and remove ozone can be coated on the counter electrode, which has a relatively large surface area, so it is easy to manufacture and has the advantage of preventing the coated catalyst material from falling off. In other words, this is because when forming the catalyst layer by coating the discharge pin of the discharge electrode with a catalyst material that can decompose and remove ozone, it is difficult to form the catalyst layer on a very small discharge pin; the amount of catalyst material and the surface area of the catalyst layer are also limited, and the discharge characteristics between the counter electrode; and the discharge electrode may change and the basic performance of the electrification unit may deteriorate. In addition, when TiO2 is used as a material constituting the catalyst layer, there is an advantage that harmful gases such as volatile organic compounds (VOC) introduced from the outside can also be removed.

In addition, although not shown, the electrostatic precipitator of the present invention includes the above electrification unit; and a dust collection unit which is stacked on one side of the electrification unit in the direction in which air flows and collects the dust particles contained in the air passing through the electrification unit by electrical attraction. Thus, the dust particles charged with a specific charge passing through the electrification unit can be collected and removed as they pass through the dust collection unit.

### Embodiment 2

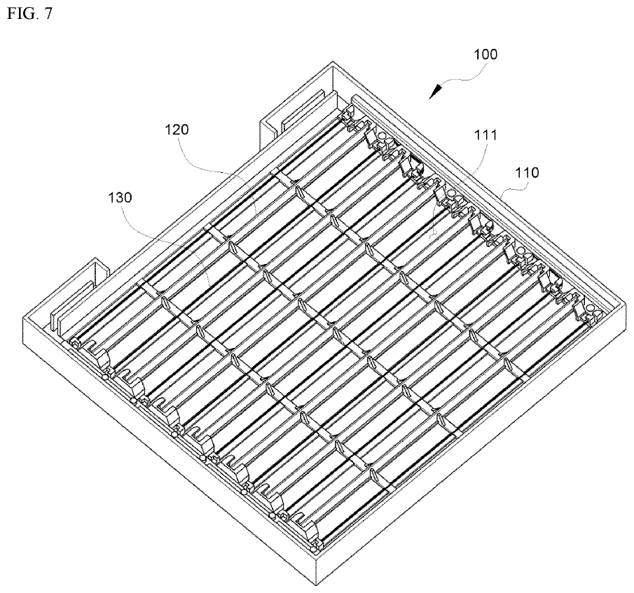

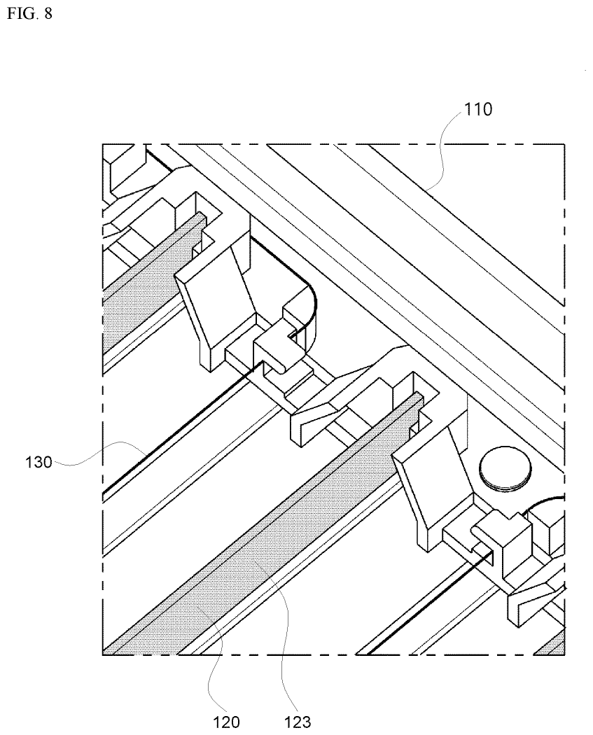

FIGS. 7 and 8 are an assembled perspective view and partially enlarged view of an electrification unit according to a second embodiment of the present invention.

As shown, the electrification unit 100 according to a second embodiment of the present invention may largely include the electrification frame 110, the counter electrode 120, and the discharge electrode 130.

For example, the electrification frame 110 may be formed in a shape in which rib is connected in the longitudinal and width directions to a square frame with an inside opening in the direction of air flow, and the through hole 111 may be formed between the square frame and the ribs. In addition, like the first embodiment, the electrification frame 110 may be formed of an insulating plastic material through injection molding. In addition, a fixing groove into which the counter electrode 120 may be coupled and fixed may be formed in the electrification frame 110, and a fixing part capable of fixing the discharge electrode 130 may be formed in the electrification frame 110.

The counter electrode 120 may be formed in the form of a plate made of a metal material whose thickness is relatively thin compared to the horizontal and vertical lengths, and the thickness direction surface of the counter electrode 120 may be disposed to face the wire-shaped discharge electrode 130 and parallel to the direction in which air flows. For example, the counter electrode 120 may be coupled and fixed by inserting both ends in the longitudinal direction into the fixing grooves of the electrification frame 110, and the counter electrode 120 is composed of a plurality of counter electrodes 120. The plurality of counter electrodes 120 may be spaced apart in the width direction and arranged side by side. In addition, the catalyst layer 123 capable of decomposing or removing ozone may be coated on the surface of the counter electrode 120.

The discharge electrode 130 is formed in the form of a wire made of metal and may be tightly fixed to a specific tensile force by hanging the discharge electrode 130 on the fixing part formed on the electrification frame 110. In addition, the discharge electrode 130 located between the counter electrodes 120 may be spaced apart from the counter electrode 120 and may be disposed in parallel with the counter electrode 120.

The catalyst layer 123 may be coated on the entire surface of the counter electrode 120, and the constituent materials and effects of the catalyst layer 123 may be the same as those of the first embodiment described above. In addition, the electrostatic precipitator including the electrification unit may be configured in the same manner as the first embodiment described above.

The present invention is not limited to the above-described embodiments but may be variously applied, and may be variously modified by those skilled in the art to which the present invention pertains without departing from the gist of the present invention claimed in the claims.

DESCRIPTION OF REFERENCE NUMERALS

| | |
|---|---|
| 100: electrification unit | 110: electrification frame |
| 111: through hole | 120: counter electrode |
| 121: upper plate | 122: side plate |
| 123: catalyst layer | 130: discharge electrode |
| 131: electrode rod | 132: discharge pin |
| 140: rod cover | |

1. An electrification unit comprising:
an electrification frame having a through-hole formed to pass through both surfaces thereof in a direction in which air including dust particles flows;
a counter electrode coupled to the electrification frame; and
a discharge electrode coupled to the electrification frame and causing corona discharge with respect to the counter electrode,
wherein a catalyst layer capable of decomposing or removing ozone is coated on a surface of the counter electrode.

2. The electrification unit of claim 1, wherein the discharge electrode includes an electrode rod and a discharge pin protruding from the electrode rod,
the counter electrode is formed in a form of a plate whose thickness is relatively thin compared to a length in width and longitudinal directions, and the counter electrode is disposed so that a surface in the width direction faces the discharge electrode, and the surface in the width direction of the counter electrode is spaced apart from the discharge pin and is formed to surround a periphery of the discharge pin.

3. The electrification unit of claim 2, wherein the counter electrode includes one layer in the direction in which the air flows, or the counter electrode includes two or more layers and the layers are spaced apart from each other in a thickness direction and stacked.

4. The electrification unit of claim 1, wherein the discharge electrode is formed in a form of a wire,
the counter electrode is formed in a form of a plate whose thickness is relatively thin compared to horizontal and vertical lengths, and a surface in a thickness direction of the counter electrode is disposed to face the discharge electrode in the form of wire.

5. The electrification unit of claim 1, wherein the counter electrode is connected to a low voltage side, and the discharge electrode is connected to a high voltage side.

6. The electrification unit of claim 5, wherein the catalyst layer is made of a material containing TiO2.

7. The electrification unit of claim 6, wherein the catalyst layer is made of a material containing an active material based on TiO2 that promotes a catalytic reaction.

8. The electrification unit of claim 7, wherein the active material includes one or more of Pt and Mn.

9. The electrification unit of claim 1, wherein the catalyst layer is made of a material containing MnO2.

10. The electrification unit of claim 1, wherein the catalyst layer is made of a catalyst material capable of decomposing harmful gases including a volatile organic compound.

11. An electrostatic precipitator, comprising:
the electrification unit of claim 1; and
a dust collection unit which is stacked on one side of the electrification unit in the direction in which the air flows and collects the dust particles included in the air passing through the electrification unit by electrical attraction.
